(19) United States
(12) Patent Application Publication
(10) Pub. No.: US 2010/0025470 A1
(43) Pub. Date: Feb. 4, 2010

(54) BAR CODE READER, OPTICAL MOUSE, AND BAR CODE READING METHOD

(76) Inventors: Katsuya Nakagawa, Shiga (JP); Shuhei Kato, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/299,115

(22) PCT Filed: May 1, 2007
(86) PCT No.: PCT/JP2007/000476

§ 371 Date: Aug. 22, 2009

(30) Foreign Application Priority Data
May 3, 2006 (JP) 2006-128754
May 6, 2006 (JP) 2006-128761
Nov. 7, 2006 (JP) 2006-301060

(51) Int. Cl. G06K 7/10

(52) U.S. Cl. 235/462.01

(57) ABSTRACT

A photo-transistor 31 is arranged to overlap with a light emitting diode 33 in a longitudinal direction of a barcode reader 7 and on a side, to which the light emitting diode 33 emits light. In this case, the photo-transistor 31 and the light emitting diode 33 are arranged on the same optical axis. As the result, since depth of focus and depth of field overlap with each other in the optical axial direction, it is believed that resolution in reading a bar-code is secured in wide range in the optical axis direction. The depth of focus includes an image point when the light emitting diode 33 is positioned at an object point. The depth of field includes an object point when the photo-transistor 31 is positioned at an image point.

### TECHNICAL FIELD

The present invention relates to a barcode reader and the related arts for reading a barcode.

Also, the present invention relates to an optical mouse and the related arts which have a barcode reading function.

Further, the present invention relates to a code issuing method and the related arts for issuing a code capable of using for delivering a content through a network.

### BACKGROUND ART

In the prior art section of Patent Document 1, a pen-shaped barcode reader (hereinafter referred to as “pen”) is disclosed. The pen presented therein is provided with a light receiving element, an aperture stop, a micro sphere, and a plurality of light emitting elements.

In Patent Document 2, an optical mouse having a barcode reading function is disclosed. Since the mouse is configured as an optical type, it has an imaging device so as to obtain a movement amount thereof. Accordingly, the mouse uses the imaging device also in reading a barcode. That is, the mouse images the barcode by the imaging device to analyze an image of the barcode in an obtained picture. Thus, in the prior art, in the case where the barcode reading function is implemented in the optical mouse, the barcode is decoded by analyzing the image of the barcode in the picture.

In Patent Document 3, a communication network system is disclosed. The system represents a destination of a content by a barcode, reads it by an optical device such as a camera, analyzes image data as read, acquires the destination, and requests to deliver the content. A barcode is assigned to an article (including electronic information) and identifies the article. This point is not limited to the prior system of Patent Document 3. The same thing can also be said about an ordinary barcode. Accordingly, the same barcodes are assigned to the same articles, and conversely the different barcodes are assigned to the different articles.

Patent Document 1: Japanese Patent Published Application No. Hei 7-192076

Patent Document 2: Japanese Patent Published Application No. 2005-4641

Patent Document 3: Japanese Patent Published Application No. 2004-30357

### DISCLOSURE OF THE INVENTION

### Problem to be Solved by the Invention

[Regarding Patent Document 1]

The above pen has the plurality of the light emitting elements to increase the amount of light to be irradiated the barcode. Therefore, it is not required to accurately design an optical system in view of a position of an image point when a light emitting element is positioned at an object point. However, since the plurality of the light emitting elements is implemented, it leads to a higher cost accordingly.

Also, in the above pen, the aperture stop (i.e., a pinhole) is disposed adjacent to the light receiving element to secure resolution in reading the barcode. However, since the aperture stop is implemented, an optical system requires high dimensional accuracy so as to align the aperture stop with an optical axis. Therefore, not only are structural parts expensive but much time also is required for assembly and adjustment. Also, since the aperture stop is disposed adjacent to the light receiving element to limit the light, light-receiving sensitivity is low. Therefore, it is required to enhance an amplification factor of an output signal from the light receiving element. As the result, since implementation of a shield is required because of increase of noise, it leads to a higher cost.

It is therefore an object of the present invention to provide a barcode reader and the related techniques thereof capable of reducing a cost as much as possible while securing resolution in reading a barcode.

[Regarding Patent Document 2]

There are not optical mice capable of decoding a barcode by means of a method other than the analysis of the image of the barcode in the picture.

It is therefore another object of the present invention to provide an optical mouse and the related techniques thereof capable of decoding a barcode by means of a novel barcode reading method.

[Regarding Patent Document 2]

It is a further object of the present invention to provide a code issuing method and the related techniques thereof capable of issuing codes whose purposes are novel.

### Solution of the Problem

In accordance with a first aspect of the present invention, a barcode leader comprising: a light emitting unit; and a light receiving unit, wherein said light receiving unit is arranged to overlap with said light emitting unit in a longitudinal direction of said barcode reader and on a side, to which said light emitting unit emits light.

In accordance with a second aspect of the present invention, a barcode leader comprising: a light emitting unit; and a light receiving unit, wherein said light receiving unit is arranged between an outgoing aperture from which light of said light emitting unit is emitted outside and said light emitting unit.

In the barcode reader in accordance with the first and second aspects of the present invention, since the light receiving unit and the light emitting unit are arranged on the same axis, the depth of focus and the depth of field can be arranged to overlap with each other in the axial direction. As the result, it is believed that resolution in reading the barcode is secured in wide range in the axial direction. The depth of focus includes the image point when the light emitting unit is positioned at the object point. The depth of field includes the object point when the light receiving unit is positioned at the image point. Also, the aperture stop (pinhole) for securing the resolution as in the prior art is not necessarily required. As a result, it is possible to reduce a cost as much as possible while securing the resolution in reading the barcode.

Needless to say, the present invention does not exclude to dispose an aperture stop for securing the resolution.

The above barcode reader in accordance with the second aspect further comprises: a first lens disposed at the outgoing aperture, wherein said first lens is a spherical lens. Also, the barcode reader further comprises: a second lens disposed between said outgoing aperture and said light receiving unit, wherein said second lens is a convex lens. Further, the barcode reader comprises: a diaphragm member disposed in contiguity with said first lens, wherein said diaphragm member has an opening, which restricts emitted light which enters said first lens from said light emitting unit and emitted light which is incoming from said first lens and then travels to said light receiving unit.

In the above barcode reader in accordance with the first and second aspects, wherein said light emitting unit and said light receiving unit are arranged in a linear fashion. In this case, wherein said light emitting unit and said light receiving unit are arranged on a substantial same axis. Also, wherein said light emitting unit and said light receiving unit are arranged at a predetermined distance from each other.

The above barcode reader in accordance with the first and second aspects further comprises: an information processing unit operable to decode the barcode based on light converted into an electrical signal, and the light has been emitted by said light emitting unit, irradiated a barcode, reflected by the barcode, and received by said light receiving unit, wherein said information processing unit converts a result of decoding of the barcode into keyboard data, and outputs the result of the decoding as the keyboard data and a predetermined command as keyboard data for having a predetermined computer perform a predetermined process using the result of the decoding.

In accordance with this configuration, the computer to which the command is inputted executes the predetermined processing in response to the command. Accordingly, in the case where the user has the computer execute the predetermined processing using the result of the decoding of the barcode, the installation of dedicated software is not required, and therefore it is possible to improve the convenience of the user.

In these barcode readers, wherein said information processing unit outputs address information of a predetermined server as keyboard data to the predetermined computer, and wherein the predetermined command is a command for having the predetermined computer transmit the result of the decoding of the barcode to the predetermined server indicated by the address information.

In accordance with this configuration, the user can send the barcode to the predetermined server to easily receive the predetermined service from the server only by performing the process of reading the barcode.

In accordance with a third aspect of the present invention, an optical mouse comprises: an imaging unit operable to photograph a surface to be photographed; an operation information obtaining unit operable to obtain operation information of said optical mouse based on pictures of the surface, which is successively photographed; and a decoding unit operable to decode a barcode based on pixel data at a predetermined location in the each pictures, which is acquired by successive photographing of said imaging unit during said imaging unit moves relative to the barcode printed on the surface.

In accordance with this configuration, in spite of the implementation of the imaging unit, the barcode is decoded based on the pixel data which is located at the predetermined location and is temporally continuous, without using image analysis which decodes the barcode based on the image of the barcode in the obtained picture. Thus, the optical mouse based on the radically novel barcode reading method, which is nonconventional, is realized.

In this optical mouse, wherein said decoding unit converts a result of decoding of the barcode into keyboard data, and outputs the result of the decoding as the keyboard data and a predetermined command as keyboard data for having a predetermined computer perform a predetermined process using the result of the decoding.

In accordance with this configuration, the computer to which the command is inputted executes the predetermined processing in response to the command. Accordingly, in the case where the user has the computer execute the predetermined processing using the result of the decoding of the barcode, the installation of dedicated software is not required, and therefore it is possible to improve the convenience of the user.

In this optical mouse, wherein the predetermined command is a command for having the predetermined computer transmit the result of the decoding of the barcode to a predetermined server.

In accordance with this configuration, the user can send the barcode to the predetermined server to easily receive the predetermined service from the server only by performing the process of reading the barcode.

In accordance with a fourth aspect of the present invention, a barcode reading method comprises the steps of: photographing a surface to be photographed while moving relative to a barcode printed on the surface; and decoding the barcode based on pixel data at a predetermined location in each picture acquired by successive photographing of the step of photographing.

In accordance with this configuration, the barcode is decoded based on the pixel data which is located at the predetermined location and is temporally continuous, without using image analysis which decodes the barcode based on the image of the barcode in the picture obtained by the photographing process. Thus, the radically novel barcode reading method, which is nonconventional, is realized.

In accordance with a fifth aspect of the present invention, a code issuing method comprises the steps of: generating codes to be assigned to respective users, and the code is represented by an image, which is distributed as electronic data by the user, and/or is attached to any article and then distributed together therewith by the user; and storing an address on a predetermined server of a content made by the user and the code relating to each other, and the content is transmitted to a client accessed the predetermined server by the predetermined server.

In accordance with this configuration, the generated code is related to the address of the content made by the user. Accordingly, a person to which the code is distributed can access the content on the predetermined server by sending the code to the server through the client. Since the code is assigned to not an article but the user and unique to the user, the user of the code can make contents independently of the article to which the code is attached.

By comparison, in the case where a code is assigned to an article, since a person to which the code is distributed accesses so as to obtain information of the article, if the contents unrelated to the article are made, they not only proves to be disappointing but also the person will never again access on the basis of the code. If a user wants a person to access the contents of the user itself which do not depend on the article, as in the present invention, the code needs to be related to the user.

Also, since the code is not assigned to the article, the user can attach the codes to the different articles even if the codes are the same as each other, and also distribute only the code independently of the articles.

In accordance with a six aspect of the present invention, a code issuing method comprises: generating codes to be assigned to respective users, and the code is represented by an image which is distributed as electronic data by the user, and/or is attached to any article and then distributed together therewith by the user, wherein the code includes an address on a predetermined server of a content made by the user, and the content is transmitted to a client accessed the predetermined server by the predetermined server.

In accordance with this configuration, the invention has the same advantage as the code issuing method according to the fifth aspect. Also, since the code includes the address in itself, the predetermined server is not required the retrieving process of the address of the content. As the result, it is possible to decrease processing load of the server.

In the above code issuing method in accordance with the fifth and sixth aspects, wherein the plurality of the different codes are issued to the one user.

In accordance with this configuration, the user can own the plurality of the different codes. That is, the user can make the contents in accordance with the respective codes. Thus, the user can deliver objective information to a person appropriate to the objective by distributing the different codes to the different receivers in accordance with the purposes. That is, the same user may want to deliver many information items. In this case, since there is not only the desired information item but also the unnecessary information item, it is inconvenient for the receiver sides. Also, the same user may want not to deliver all information items to all persons. That is, he/she may want to deliver specific information item only to a particular person.

In the above code issuing method in accordance with the fifth and sixth aspects, wherein the image is a barcode pattern, and the code is a barcode. Since the barcodes are widely distributed, it is possible to provide many people with inexpensive barcode readers. Therefore, it makes the system for accessing the content using the barcode pervasive widely. Also, wherein the content is a WEB page, and the address is a URL.

In accordance with a seventh aspect of the present invention, a code pattern is distributed as electronic data by each user, and/or is attached to any article and then distributed together therewith by the each user, and comprises: a graphic pattern, wherein said code pattern represents a code assigned to the each user in accordance with a predetermined rule as said graphic pattern, and is related to an address on a predetermined server of a content made by the user, and wherein the content is transmitted to a client accessed the predetermined server by the predetermined server. In accordance with this configuration, the invention has the same advantage as the code issuing method according to the fifth aspect.

In accordance with a eighth aspect of the present invention, a code pattern is distributed as electronic data by each user, and/or is attached to any article and then distributed together therewith by the each user, and comprises: a graphic pattern, wherein said code pattern represents a code assigned to the each user in accordance with a predetermined rule as said graphic pattern, wherein the code includes an address on a predetermined server of a content made by the user, and wherein the content is transmitted to a client accessed the predetermined server by the predetermined server. In accordance with this configuration, the invention has the same advantage as the code issuing method according to the sixth aspect.

In accordance with a ninth aspect of the present invention, a content delivering method uses the code pattern in accordance with the seventh aspect, and comprises the steps of: receiving a code corresponding to the code pattern by a server, which is transmitted by a client; and transmitting a content, which is stored in a location indicated by an address related to the received code, to the client by the server. In accordance with this configuration, the invention has the same advantage as the code issuing method according to the fifth aspect.

In accordance with a tenth aspect of the present invention, a content delivering method uses the code pattern in accordance with the eighth aspect, and comprises the steps of: receiving a code corresponding to the code pattern by a server, which is transmitted by a client; and transmitting a content, which is stored in a location indicated by an address included in the received code, to the client by the server. In accordance with this configuration, the invention has the same advantage as the code issuing method according to the sixth aspect.

In the above content delivering method in accordance with the ninth and tenth aspects, wherein the code is transmitted by the client in response to a command, which is given by a predetermined input unit, after decoding the code by the predetermined input unit.

In accordance with this configuration, the client to which the command is inputted executes the transmitting process in response to the command. Accordingly, in the case where the client executes the process for transmitting the code, the installation of dedicated software is not required. Also, it is possible to send the code to the predetermined server only by performing the process of reading the code by the predetermined input unit. As the result, it is possible to improve the convenience of the person, which accesses the content sending the code.

### BRIEF DESCRIPTION OF DRAWINGS

The novel features of the present invention are set forth in the appended any one of claims. The invention itself, however, as well as other features and advantages thereof, will be best understood by reference to the detailed description of specific embodiments which follows, when read in conjunction with the accompanying drawings, wherein:

FIG. 1 is a view showing the overall configuration of a remote barcode reader system in accordance with an embodiment of the present invention.

FIG. 2 is a structural drawing for showing an example of the barcode reader 7 shown in FIG. 1.

FIG. 3(a) is a schematic diagram for showing the electric configuration of the barcode reader 7 shown in FIG. 2. FIG. 3(b) is an explanatory schematic diagram for showing programs and data segments stored in a ROM 47 embedded in the MCU 37 shown in FIG. 3(a).

FIG. 4 is a schematic diagram for showing one example of the communication procedure among the local barcode reader 7, the communication terminal 5 and the host computer 1 as illustrated in FIG. 1.

FIG. 5 is a perspective external view for showing a PC 61 and a BC mouse 63.

FIG. 6 is a functional block diagram for showing the BC mouse 63 of FIG. 5.

FIG. 7 is an explanatory view for showing a barcode reading method of the BC mouse 63 of FIG. 5.

FIG. 8 is a view for showing examples of a barcode 11, pixel data P(t) at a predetermined location (n, m) in a frame picture 311, and binary data thereof.

FIG. 9 is a flow chart for showing an example of the process of the barcode decoder 314 of FIG. 6.

FIG. 10 is a schematic representation of a business model realized by a barcode service providing system in accordance with an embodiment of the present invention.

FIG. 11 is an explanatory view of barcode assignment.

FIG. 12 is a schematic view for showing the communication procedure between the receiver group 117-n of FIG. 10 and the server 113 of the barcode service provider 105.

FIG. 13 is a flow chart for showing the process of issuing the barcode by the barcode issuing system 107 of FIG. 10.

FIG. 14 is a schematic representation of a URL reference file 121 stored in the database 109 of FIG. 10.

FIG. 15 is an explanatory view for showing a modification of the barcode issuing system 107 of FIG. 10.

### EXPLANATION OF REFERENCES

1 . . . host computer, 3 . . . Internet, 5 . . . terminal, 7 . . . local barcode reader, 9 . . . user network, 11, 131 . . . barcode, 21 . . . housing, 23 . . . spherical lens, 25 . . . diaphragm member, 27 . . . opening, 29 . . . convex lens, 31 . . . photo-transistor, 33 . . . light emitting diode, 37 . . . MCU, 38 . . . substrate, 39 . . . amplifier, 41 . . . USB cable, 43 . . . scanner, 47 . . . ROM, 63 . . . BC mouse, 307 . . . mouse function unit, 308 . . . light emitting unit, 310 . . . imaging unit, 314 . . . barcode decoder, 318 . . . transmitter, 100 . . . user, 103 . . . applying and issuing path, 105 . . . barcode service provider, 107 . . . barcode issuing system, 109 . . . database, 113 . . . server, 115 . . . delivering path, 61, 119, 135 . . . PC, 117-0 to 117-N . . . receiver group, 133 . . . barcode reader, 137 . . . network.

### BEST MODE FOR CARRYING OUT THE INVENTION

In what follows, several embodiments of the present invention will be explained in detail with reference to the accompanying drawings. Meanwhile, like references indicate the same or functionally similar elements throughout the respective drawings, and therefore redundant explanation is not repeated.

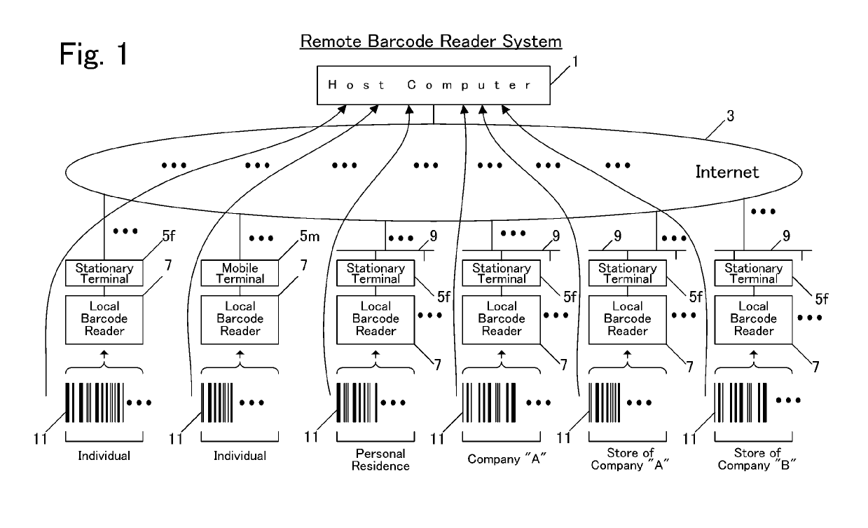

FIG. 1 is a view showing the overall configuration of a remote barcode reader system in accordance with an embodiment of the present invention. Referring to FIG. 1, the remote barcode reader system includes a host computer 1, and a plurality of arbitrary local barcode readers 7 capable of reading arbitrary barcodes 11. The local barcode reader 7 may be for example a pen scanner, a CCD touch scanner, a handheld laser scanner, a desktop laser scanner, a slot reader, or any other type of barcode reader.

In the context of this document, the term “barcode” is intended to generally represent barcode information or a barcode pattern, so that when there is no need to distinguish the barcode information and the barcode pattern, the term “barcode” is simply used. From a different view point, the barcode is a code which is assigned to an article (tangible entity such as goods or estate, intangible entity such as service or information (image, sound, program, data or the like), commodity, or, human being, animal or another living being), or any other thing which can be identified by some means.

The barcode information represents a string of characters such as numerals, letters, symbols and the like. The barcode pattern is a pattern of black bars and white spacings which are combined in order to encode the barcode information. Incidentally, the barcode and the barcode pattern are given the same reference numeral “11”.

The host computer 1 and each of the local barcode readers 7 are connected with each other through the Internet 3, and a stationary terminal 5f or a mobile terminal 5m. The stationary terminal 5f may be any type of fixed line terminal such as a desktop computer provided with communication functionality. The mobile terminal 5m may be any type of wireless communication terminal such as a notebook computer or any type of portable computer, which is provided with communication functionality, a cellular phone, or a PDA (Personal Digital Assistant). Incidentally, when there is no need to distinguish the stationary terminal 5f and the mobile terminal 5 m, the term “terminal 5” is simply used.

The illustrated example will be explained. The local barcode reader 7 used by a certain individual is connected to the Internet 3 through the stationary terminal 5f and an access network which is not shown in the figure, and connected to the host computer 1 through an access network which is not shown in the figure. The local barcode reader 7 used by another individual is connected to the Internet 3 through the mobile terminal 5 m and an access network which is not shown in the figure, and connected to the host computer 1 through the access network. The local barcode reader 7 used in the house of an individual is connected to the Internet 3 through the stationary terminal 5f, a user network 9 such as a LAN and an access network which is not shown in the figure, and connected to the host computer 1 through the access network.

The local barcode reader 7 used in a company “A” (company having a chain of convenience stores) is connected to the Internet 3 through the stationary terminal 5f, a user network 9 such as a LAN and an access network which is not shown in the figure, and connected to the host computer 1 through the access network. The local barcode reader 7 used in a store (for example, a convenience store) operated by the company “A” is connected to the Internet 3 through the stationary terminal 5f, a user network 9 such as a LAN and an access network which is not shown in the figure, and connected to the host computer 1 through the access network.

The local barcode reader 7 used in a store operated by a company “B” which is a different company than the company “A”, for example, a rival company is connected to the Internet 3 through the stationary terminal 5f, a user network 9 such as a LAN and an access network which is not shown in the figure, and connected to the host computer 1 through the access network.

In this case, the local barcode readers 7 and the stationary terminals 5f used in the stores of the companies “A” and “B” are not POS terminals. However, they can be POS terminals.

While the example shown in the figure is illustrative only, a number of various and arbitrary local barcode readers 7 are connected with the host computer 1 through various networks inclusive of the Internet 3, regardless of the individuals and enterprises. Accordingly, the host computer 1 can globally collect a number of various and arbitrary barcodes. The barcodes 11 are classified into a plurality of groups. The host computer 1 performs a process in accordance with the group to which the barcode 11 belongs, and provides a service to the user by performing this process. In this case, the host computer 1 can provide a service (including content) through the terminal 5 and the Internet 3. However, in response to the processing result of the host computer 1, it is possible to provide a service through not only the Internet 3 but also WAN (Wide Area Network), LAN (Local Area Network) or any other network, or a combination thereof. The barcodes 11 can be collected in the same manner. Incidentally, WAN includes a public switched telephone network, an exclusive line network, a power line communication network, a CATV network and so forth. Alternatively, in response to the processing result of the host computer 1, it is also possible to provide a service through another route (broadcast, postal mail, another communication tool, door-to-door parcel delivery service, and so forth) without using a network. In other words, while the network has to be used for collecting the barcodes 11, any other appropriate means can be used for providing a service to the user.

Next, the above groups into which the barcodes 11 are classified will be described by way of example. The first example is a group of barcodes which are printed on paper mediums such as magazines. The host computer 1 receives a barcode belonging to this group, gives the terminal 5 the URL of a website in which is placed the information about the paper medium printed with the barcode, or content described in the paper medium (for example, advertisement). The information is then displayed on the terminal 5. The second example is a group of barcodes which are assigned to companies respectively in a printed material such as Kaisha Shikiho describing stock price information. The host computer 1 receives a barcode belonging to this group, gives the terminal 5 the URL of a website in which is placed the stock price information about the company corresponding to this barcode. The information is then displayed on the terminal 5.

The third example is a group of barcodes which are assigned to companies respectively in a printed material describing job information. The host computer 1 receives a barcode belonging to this group, gives the terminal 5 the URL of a website in which is placed the job information about the company corresponding to this barcode. The information is then displayed on the terminal 5. The fourth example is a group of barcodes which are assigned to landscapes respectively in a printed material showing landscape photographs. The host computer 1 receives a barcode belonging to this group, gives the terminal 5 the URL of a website in which is placed the detailed information about the landscape corresponding to this barcode. The information is then displayed on the terminal 5.

The fifth example is a group of barcodes which are assigned to articles respectively in a newspaper. The host computer 1 receives a barcode belonging to this group, gives the terminal 5 the URL of a website in which is placed the detailed information about the article corresponding to this barcode. The information is then displayed on the terminal 5. The sixth example is a group of barcodes which are assigned to name cards respectively. The host computer 1 receives a barcode belonging to this group, gives the terminal 5 the URL of a website in which is placed the detailed information about the holder of the name card corresponding to this barcode. The information is then displayed on the terminal 5.

The seventh example is a group of barcodes which are assigned to chapters of a book respectively. The host computer 1 receives a barcode belonging to this group, gives the terminal 5 the URL of a website in which is placed the detailed information about the chapter corresponding to this barcode. The information is then displayed on the terminal 5. The eighth example is a group of barcodes which are assigned to the titles of music CDs or cinema DVDs respectively. The host computer 1 receives a barcode belonging to this group, gives the terminal 5 the URL of a website which enables listening/watching the music or movie corresponding to this barcode. The title is played on the terminal 5.

The ninth example is a group of barcodes which are assigned to pictures of trading cards respectively. The host computer 1 receives a barcode belonging to this group, gives the terminal 5 the URL of a website in which is placed the information about the picture corresponding to this barcode. The information is then displayed on the terminal 5. The tenth example is a group of barcodes which are printed on purchase receipts issued after shopping respectively. The host computer 1 receives a barcode belonging to this group, gives the terminal 5 the URL of a website in which is placed the information about the store having issued the purchase receipt corresponding to this barcode (for example, information for sale). The information is then displayed on the terminal 5.

The eleventh example is a group of barcodes corresponding to standard commodity codes. The host computer 1 receives a barcode belonging to this group, gives the terminal 5 the URL of a website in which is placed the information about the good corresponding to this barcode. The information is then displayed on the terminal 5. The standard commodity codes are codes used by a POS (Point Of Sale) system, and include codes according to JAN (Japanese Article Number), EAN (European Article Number), and UPC (Universal Product Code) and so forth.

As has been discussed above, in accordance with the present system, while the barcode 11 is classified into one of the plurality of groups, the host computer 1 performs the process corresponding to the group to which the received barcode 11 belongs, and provides the terminal 5 with the content which is given according to this group and corresponding to the received barcode 11. Incidentally, the aforementioned groups are illustrative only, but needless to say the present invention is not limited thereto.

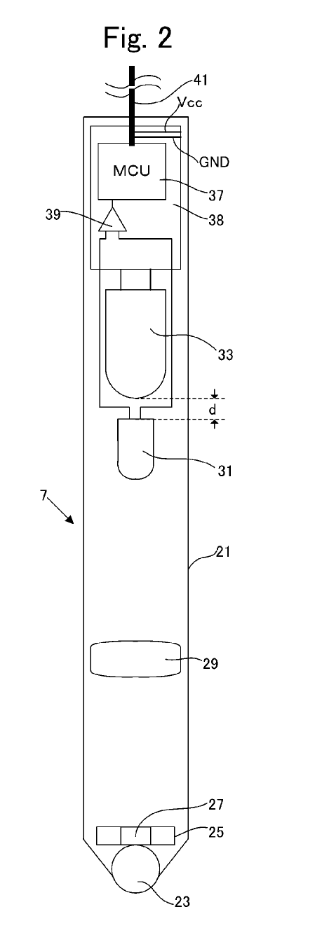

FIG. 2 is a structural drawing for showing an example of the barcode reader 7 shown in FIG. 1. Referring to FIG. 2, the barcode reader 7 has a cylindrical housing 21. Then, a substrate 38 on which an MCU (Micro Controller Unit) 37 and an amplifier 39 are mounted, a light emitting diode 33, a photo-transistor 31, a convex lens 29, a diaphragm member 25, and a spherical lens 23 are incorporated in the housing 21.

The substrate 38 is positioned at a base end section of the barcode reader 7. A power supply voltage Vcc and a ground voltage GND are supplied with the substrate 38 through a USB cable 41 whose one end is connected with the MCU 37, and then are supplied with the MCU 37, the amplifier 39, the photo-transistor 31, and the light emitting diode 33.

The photo-transistor 31 converts light as inputted into an electrical signal to output it to the amplifier 39. The amplifier 39 amplifies the electrical signal outputted from the photo-transistor 31 to output it to the MCU 37. The MCU 37 decodes the electrical signal to obtain barcode information. Also, the MCU 37 has a function as a USB controller, and whereby communicates with a USB controller (not shown in the figure) which is connected with the other end of the USB cable 41 to transmit the barcode information as obtained.

The photo-transistor 31 is arranged to overlap with the light emitting diode 33 in a longitudinal direction of the barcode reader 7 and on a side, to which the light emitting diode 33 emits light. The lens 23 is disposed to an outgoing aperture from which the light of the light emitting diode 33 is emitted. Also, the cylindrical diaphragm member 25 is disposed in contiguity with the lens 23. The diaphragm member 25 is provided with an opening 27, which restricts emitted light which enters the lens 23 from the light emitting diode 33 and emitted light which is incoming from the lens 23 and then travels to the photo-transistor 31. Meanwhile, the opening 24 is not an aperture for securing resolution in reading a bar-code, i.e., is not a pinhole. Also, the lens 29 is disposed between the photo-transistor 31 and the diaphragm member 25.

To put it in detail, the photo-transistor 31 and the light emitting diode 33 are substantially arranged on the same axis, i.e., an optical axis of the lens 29. Also, the photo-transistor 31 and the light emitting diode 33 are arranged along the optical axis of the lens 29 and at a predetermined distance “d” from each other. The predetermined distance “d” will be described below. Further, since the emitted light from the light emitting diode 33 needs to enter the lens 23, a size of the photo-transistor 31 is set so as not to block out the emitted light from the light emitting diode 33. For example, when the photo-transistor 31 and the light emitting diode 33 are seen from the optical axis direction of the lens 29, their sizes are set so that the photo-transistor 31 (its plastic mold) is smaller than the light emitting diode 33 (its plastic mold).

The lens 23 is fixed to the outgoing aperture. Accordingly, it is possible to adjust a position of an image point when the light emitting diode 33 is positioned at an object point by adjusting the positions of the lens 29 and the light emitting diode 33 (on the optical axis). Also, it is possible to adjust a position of an object point when the photo-transistor 31 is positioned at an image point by adjusting the positions of the lens 29 and the photo-transistor 31 (on the optical axis).

When the photo-transistor 31 and the light emitting diode 33 are arranged on the optical axis of the lens 29 and the predetermined distance “d” is appropriately set, it allow depth of focus and depth of field to overlap with each other in the optical axial direction (hereinafter referred to as “double focus”). As the result, it is believed that resolution in reading a bar-code is secured in wide range in the optical axis direction. The depth of focus includes the image point when the light emitting diode 33 is positioned at the object point. The depth of field includes the object point when the photo-transistor 31 is positioned at the image point. In this case, it is possible to set the position of the double focus outside of the barcode reader 7 and near the lens 23 by appropriately setting position relation among the light emitting diode 33, the photo-transistor 31, the lens 29, and the lens 23 on the basis of experiments, trial and error processes, and so on.

The method for setting the predetermined distance “d” will be described in detail. If the predetermined distance “d” is too short, since the photo-transistor 31 directly receives the emitted light from the light emitting diode 33, it is not possible to distinguish reflected light from a barcode. That is, in this case, the photo-transistor 31 is completely turned on by the direct light from the light emitting diode 33, or is in a state close thereto. On the other hand, to increase response speed of the photo-transistor 31, the photo-transistor 31 should keep a state, in which the photo-transistor 31 is weakly turned on. Further, if the predetermined distance “d” is too long, since the depth of focus and the depth of field do not overlap with each other and separates from each other, the double focus is not realized, and therefore a range (on the optical axis), on which it is not possible to recognize a barcode with high accuracy, results. As the result, the predetermined distance “d” is set on the basis of experiments, trial and error processes, or the like so that the photo-transistor 31 is weakly turned on so as not to be completely turned on and the double focus is realized.

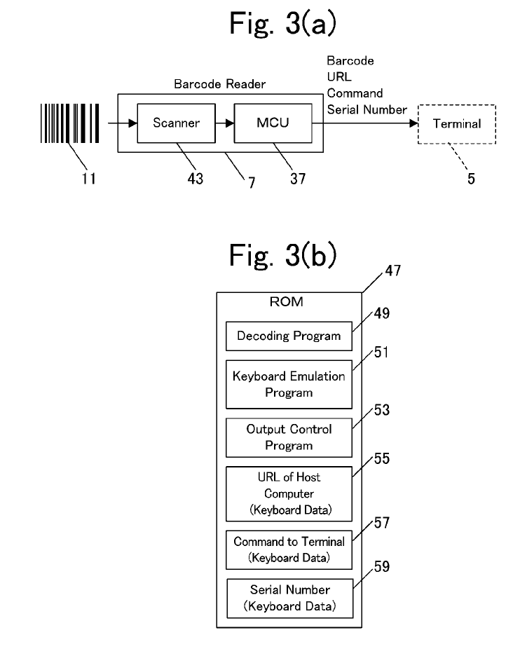

FIG. 3(a) is a schematic diagram for showing the electric configuration of the barcode reader 7 shown in FIG. 2. FIG. 3(b) is an explanatory schematic diagram for showing programs and data segments stored in a ROM 47 embedded in the MCU 37 shown in FIG. 3(a). Referring to FIG. 3(a), the barcode reader 7 includes a scanner 43 and the MCU 37. The scanner 43 includes the optical system shown in FIG. 2 (the amplifier 39, the light emitting diode 33, the photo-transistor 31, the lens 29, the diaphragm member 25, and the lens 23).

The light, which the light emitting diode 33 of the scanner 43 emits, is irradiated a barcode 11 through the lens 29, the diaphragm member 25, and the lens 23. Then, the light irradiated the barcode 11 is received by the photo-transistor 31 through the lens 23, the diaphragm member 25, and the lens 29. The photo-transistor 31 converts the received light into an electrical signal. The electrical signal is amplified by the amplifier 39 and then sent the MCU 37. In this way, MCU 37 receives the electrical signal corresponding to bars and spacings constituting the barcode.

The MCU 37 includes, as built-in elements, a CPU (not shown in the figure), a RAM (not shown in the figure), an A/D converter (not shown in the figure), a USB controller (not shown in the figure), the ROM 47 shown in FIG. 3(b) and so forth. The ROM 47 is used to store a decoding program 49, a keyboard emulation program 51, an output control program 53, a URL (Uniform Resource Locator) 55 of the host computer 1 provided in terms of keyboard data, a command 57 provided in terms of keyboard data to be issued to the terminal 5, a serial number 59 provided in terms of keyboard data, and any other necessary programs and data.

The command 57 is a command which is used to instruct the terminal (computer) 5 to run a browser and access the host computer 1 by the use of the URL 55. For example, in the case where the OS (Operating System) is Windows (registered trademark), the command is provided as the keyboard data corresponding to a GUI (Graphical User Interface) key+“R” key of a keyboard if the OS is Windows 98 or latter version. Windows launches a browser (Internet Explorer™) in response to this command. In other words, this command is included as a default command of Windows which is an OS. Meanwhile, the GUI key of Windows is generally referred to as Windows key. Since the local barcode reader 7 stores and outputs the command of an OS such as Windows which is taking a significant market share, it is possible to make use of most terminals as the terminal 5 for the present system by an easy procedure, i.e., only by connecting the local barcode reader 7 to the terminal 5. Because of this, the local barcode reader 7 need not store a plurality of commands in advance, and recognize the OS used by each terminal 5, select and use one of the commands, and so forth.

The serial number 59 is a unique number that is assigned to identify the local barcode reader 7.

The MCU 37 runs the decoding program 49, decodes the electrical signal corresponding to the barcode 11 which is input, and acquires barcode information. Then, the MCU 37 runs the keyboard emulation program 51, converts the barcode information into keyboard data, and stores the keyboard data in the RAM. Then, the MCU 37 runs the output control program 53, acquires the command 57, the URL 55 and the serial number 59 from the ROM 47, acquires the barcode information from the RAM, and makes the USB controller transmit the keyboard data thereof to the terminal 7.

Then, in response to the received command 57, the terminal 5 transmits the barcode information and the serial number 59 to the host computer 1 with reference to the received URL 55 through the Internet 3. Incidentally, while the personal information of the user can optionally be registered from the terminal 5, it requires careful handling. In connection with the serial number 59 which is acquired by the host computer 1, the personal information has to be handled particularly in a careful way.

Meanwhile, it is possible to make changeable the URL and the programs by the use of an EEPROM, a flash memory or the like, provided outside the MCU 37.

By the way, as has been discussed above, in the barcode reader 7 of FIG. 2, the photo-transistor 31 is arranged to overlap with the light emitting diode 33 in the longitudinal direction of the barcode reader 7 and on the side, to which the light emitting diode 33 emits the light. In other words, the photo-transistor 31 is arranged between the outgoing aperture (the lens 23) from which the light of the light emitting diode 33 is emitted outside and the light emitting diode 33. In this case, the photo-transistor 31 and the light emitting diode 33 are arranged on the same optical axis. Thus, it allows the depth of focus and the depth of field to overlap with each other in the optical axial direction. As the result, it is believed that resolution in reading a bar-code is secured in wide range in the optical axis direction. The depth of focus includes the image point when the light emitting diode 33 is positioned at the object point. The depth of field includes the object point when the photo-transistor 31 is positioned at the image point.

Also, the aperture stop for securing the resolution, i.e., the pinhole as in the prior art, is not disposed. Accordingly, it is possible to secure a sufficient amount of light quantity as input to the photo-transistor 31. As the result, it is possible to set a smaller amplification factor as compared with the case where the pinhole is disposed, and the shield for preventing the noise can be omitted. In addition, the optical system does not require high dimensional accuracy.

As a result, it is possible to reduce a cost as much as possible while securing the resolution in reading a bar-code.

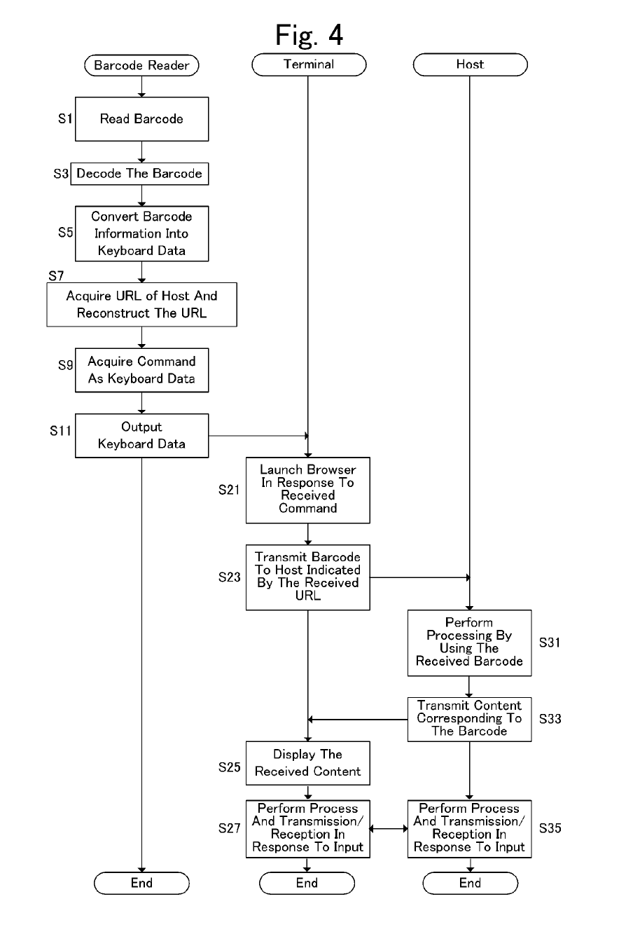

FIG. 4 is a schematic diagram for showing one example of the communication procedure among the local barcode reader 7, the communication terminal 5 and the host computer 1 as illustrated in FIG. 1.

Referring to FIG. 4, in step S1, the local barcode reader 7 reads the barcode pattern 11 in response to the operation of a user. In step S3, the local barcode reader 7 decodes the barcode pattern 11 on the basis of a known barcode decoding technique.

In step S5, the local barcode reader 7 converts the barcode information which is the result of decoding into keyboard data, and stores the keyboard data in the RAM. Then, in step S7, the local barcode reader 7 acquires the URL 55 of the host computer 1 (for example, “http://www.ssd.co.jp”) from the ROM 47 as keyboard data, appends the barcode information (for example, “4560256580016”) and the serial number 59 (for example, “13222159”) as keyboard data to the end of the URL 55, and stores it in the RAM as a new URL (for example, “http://www.ssd.co.jp/?bc=4560256580016&sn=13222159”).

In step S9, the local barcode reader 7 acquires the command 57 from the ROM 47 in the form of keyboard data which instructs the terminal 5 to launch the browser and access the host computer 1, and stores the command 57 in the RAM. In step S11, the local barcode reader 7 outputs the keyboard data (the command 57 and the URL (the URL 55+the barcode information+the serial number 59) to the terminal 5.

The terminal 5 receives the keyboard data which is output from the local barcode reader 7. Then, the terminal 5 launches the browser in response to the command 57 sent from the local barcode reader 7 in step S21, and accesses the host computer 1 with reference to the URL sent from the local barcode reader 7 in step S23. At this time, the URL is transmitted to the host computer 1.

The host computer 1 then receives the URL (including the barcode information and the serial number 59). And, in step S31, the host computer 1 performs the process corresponding to the group to which the received barcode 11 belongs, and generates the content which is provided corresponding to this group and corresponding to the barcode information. In step S33, the host computer 1 transmits the content corresponding to the barcode information (for example, which is described in HTML) as a result of the process in step S31, to the terminal 5.

In step S25, the terminal 5 displays the content, which is transmitted from the host computer 1, in a display (for example, by parsing the HTML information and displaying a web page). In step S27, the terminal 5 performs processing and communication with the host computer 1 in response to the input operation by the user. Likewise, in step S35, the host computer 1 performs processing and communication with the terminal 5 in response to the access from the terminal 5. Meanwhile, the content transmitted from the host computer 1 to the terminal 5, i.e., the content which is provided for the user is an example of a service which is provided for the user.

Next is a supplementary explanation of step S23. More specifically, in step S23, the terminal 5 accesses a DNS (Domain Name System) server, acquires an IP address corresponding to a domain name (“www.ssd.co.jp” in the aforementioned example), transmits the aforementioned URL including the barcode information and the serial number 59 to the network including the Internet 3 together with the IP address, and transmits the barcode information and the serial number 59 to the host computer 1 by accessing the host computer 1. However, detailed description of the above processing is dispensed with because these steps are performed by well-known protocols.

As has been discussed above, in the case of the present embodiment, a number of various and arbitrary local barcode readers 7 are connected with the host computer 1 through various networks inclusive of the Internet 3 and a number of arbitrary terminals 5 which are connected to these networks. In other words, a number of various and arbitrary local barcode readers 7 are connected with the host computer 1, regardless of the individuals and enterprises. Accordingly, the host computer 1 can globally collect a number of various and arbitrary barcodes 11. The host computer 1 performs a process in accordance with the group belonging to the barcode 11, and transmits to the terminal 5 the content which is provided corresponding to this group and corresponding to the barcode 11. Thereby, the terminal 5 can display a variety items of content in accordance with the barcodes 11. In other words, in response to the barcode 11 transmitted to the host computer 1, the user of the local barcode reader 7 can receive a variety of services which are provided by the host computer 1 in correspondence with the barcode 11. In this case, as long as the user possesses at least one local barcode reader 7, he can receive a variety of different services. For example, the user can receive any service of the first to eleventh examples as described above only by the use of a single local barcode reader 7. In addition to this, only by scanning a barcode 11, the user of the local barcode reader 7 can readily receive the service and content provided corresponding to this barcode 11 with no need to search websites for receiving the desired service and content.

Furthermore, in the case of the present embodiment, the local barcode reader 7 outputs the URL 55 of the host computer 1 and the command 57 to the terminal 5 together with the barcode 11. In response to this, the terminal 5 transmits the barcode 11 to the host computer 1. Namely, the transmission of the barcode 11 can be triggered by scanning the barcode 11. Because of this, the user of the local barcode reader 7 can transmit the barcode 11 to the host computer 1 only by reading the barcode 11 through the local barcode reader 7 without need for any particular operation of the terminal 5. In addition, the user need neither install software in the terminal 5 nor input the URL 27 of the host computer 1 for transmitting the barcode 11 to the host computer 1. As a result, it is possible to improve the convenience of the user.

Furthermore, since the serial number 59 of the local barcode reader 7 is transmitted to the host computer 1, the user can receive content provided for him irrespective of the terminal 5 to which his own local barcode reader 7 is connected. In other words, as long as the user uses his own local barcode reader 7, the user can receive content provided for him through the arbitrary terminal 5. Needless to say, in this case, the host computer 1 performs a process associated with the serial number 59 of the local barcode reader 7, and transmits content corresponding to the serial number 59, to the terminal 5. Meanwhile, the transmission of the serial number 59 from the local barcode reader 7 or the terminal 5 is optionally performed, but can be dispensed with.

Incidentally, while the host computer 1 serves as a Web server in the above example, the present invention is not limited thereto. However, of course, the present invention can also be applied in a different way in which the protocol supported by the host computer 1 serving as another type of server is used with a different URL. The host computer 1 may further be provided with a plurality types of server functions.

By the way, next, an example, in which a personal computer (PC) is used as the stationary terminal 5f of FIG. 1 and a BC mouse 63 is used instead of the local barcode reader 7, will be described.

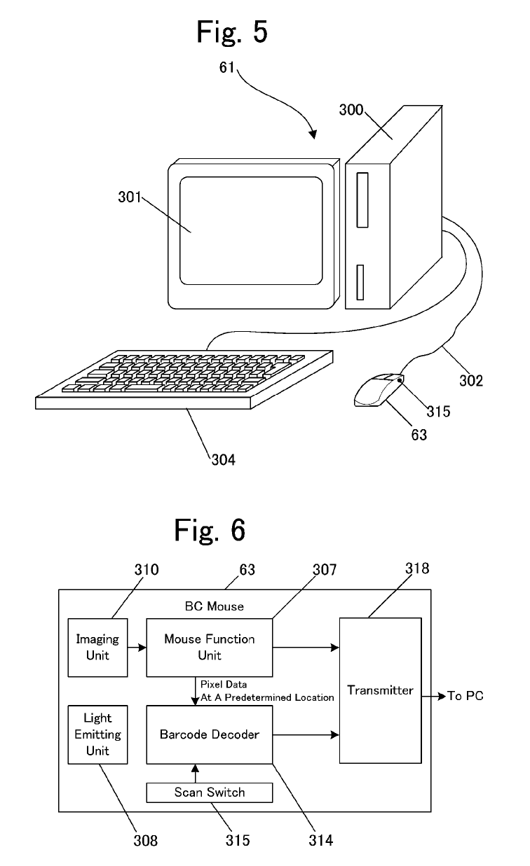

FIG. 5 is a perspective external view for showing the PC 61 and the BC mouse 63. Referring to FIG. 5, the PC 61 includes a computer unit 300, a monitor 301, a keyboard 304 and the BC mouse 63. The BC mouse 63 is coupled with the computer unit 300 of the PC 61 by a USB (Universal Serial Bus) cable 302. The BC mouse 63 is provided with a scan switch 315, which is continuously held down in scanning the barcode 11, on the side thereof.

FIG. 6 is a functional block diagram for showing the BC mouse 63 of FIG. 5. Referring to FIG. 6, the BC mouse 63 includes an imaging unit 310 having an image sensor (not shown in the figure), which photographs a surface to be photographed, a light emitting unit 308 having a light emitting diode (not shown in the figure), which emits light to the surface to be photographed, a mouse function unit 307, the scan switch 315, a barcode decoder 314, and a transmitter 318.

First, a function as an ordinary mouse will be described simply. The imaging unit 310 photographs the surface to be photographed, i.e., a surface under the BC mouse 63 in a predetermined period T, and sequentially outputs frame pictures as obtained to the mouse function unit 307. The mouse function unit 307 converts these frame pictures into digital data and stores them, and computes a moving direction and a moving amount of the BC mouse 63, i.e., operation information of the BC mouse 63 by comparing the same images (e.g., a specified pattern on a desk, which is the surface to be photographed) in the respective frame pictures. Then, the mouse function unit 307 outputs the operation information as computed to the transmitter 318. For example, the mouse function unit 307 may be formed from a DSP (Digital Signal Processor) and a program which has the DSP execute the above processing.

Next, a function for reading a barcode will be described. When the user slides a bottom of the optical mouse 63 on the barcode 11 while holding the scan switch 315 down, the barcode 11 is read and then decoded. Meanwhile, the optical mouse 63 is provided with a photographing window for the image sensor of the imaging unit 310 in the bottom thereof. This point is similar to a ordinary optical mouse. The details are follows.

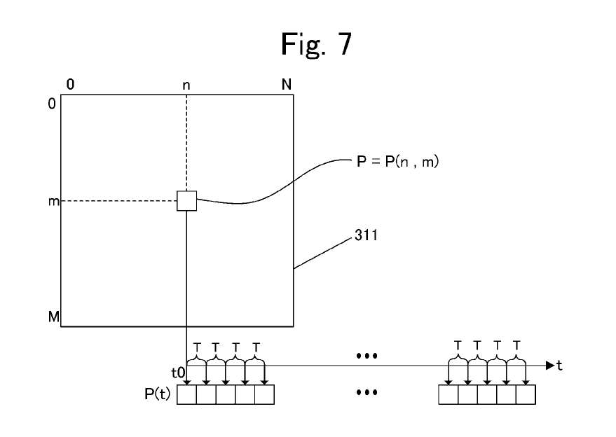

FIG. 7 is an explanatory view for showing a barcode reading method of the BC mouse 63 of FIG. 5. Referring to FIG. 7, it is assumed that a frame picture 311 outputted from the imaging unit 310 has been converted into the digital data. The image sensor of the imaging unit 310, i.e., the frame picture 311 consists of (N+1)*(M+1) of pixels. The mouse function unit 307 outputs pixel data P (n, m) at a predetermined location (n, m) to the barcode decoder 314 each time the frame picture 311 is acquired. That is, the mouse function unit 307 sequentially outputs the pixel data P (n, m) to the barcode decoder 314 in the imaging period T of the imaging unit 310. The references “n” and “m” represent constants respectively.

Meanwhile, the pixel data P(n,m), which is sequentially outputted, is referred to as “P(t)”. The variable “t” is a value of integral multiple of the imaging period T.

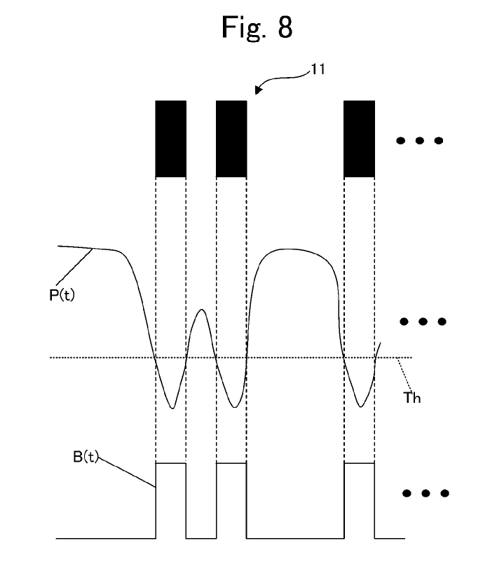

FIG. 8 is a view for showing examples of the barcode 11, the pixel data P(t) at the predetermined location (n, m) in the frame picture 311, and the binary data thereof. Referring to FIG. 8, level of the pixel data P(t) changes depending on a black-and-white pattern of the barcode 11. That is, level of brightness decreases when the pixel data P(t) represents a black bar, and conversely the level of the brightness increases when the pixel data P(t) represents a white spacing.

The barcode decoder 314 compares the pixel data P(t) as sequentially inputted with a predetermined threshold value Th to obtain the binary data B(t). That is, the barcode decoder 314 determines that the pixel data P(t) represents the white spacing when the pixel data P(t) exceeds the predetermined threshold value Th, and sets the binary data B(t) of the pixel data P(t) to “0”. On the other hand, the barcode decoder 314 determines that the pixel data P(t) represents the black bar when the pixel data P(t) is the predetermined threshold value Th or less, and sets the binary data B(t) of the pixel data P(t) to “1”.

In this way, the barcode decoder 314 binarizes the pixel data P(t) as sequentially inputted, and decodes the barcode 11 based on the obtained data B (t) by means of a known decoding technique. Then, the barcode decoder 314 converts the result of the decoding, i.e., the barcode information into the keyboard data and then outputs it to the transmitter 318. Also, the barcode decoder 314 outputs the command, which is used to instruct the PC 61 to run a browser and transmit the barcode information to the host computer 1, as the keyboard data to the transmitter 318. However, when the barcode 11 is scanned under a condition where the user keeps holding the scan switch 315 down, the barcode decoder 314 performs the decoding process and the command issuing process. For example, the barcode decoder 314 may be formed from an MCU (Micro Controller Unit) and a program which has the MCU execute the above processing.

The transmitter 318 selectively transmits the operation information as sent from the mouse function unit 307 and the keyboard data as sent from the barcode decoder 314 in accordance with a request of the PC 61. For example, the transmitter 318 may be formed from a USB controller.

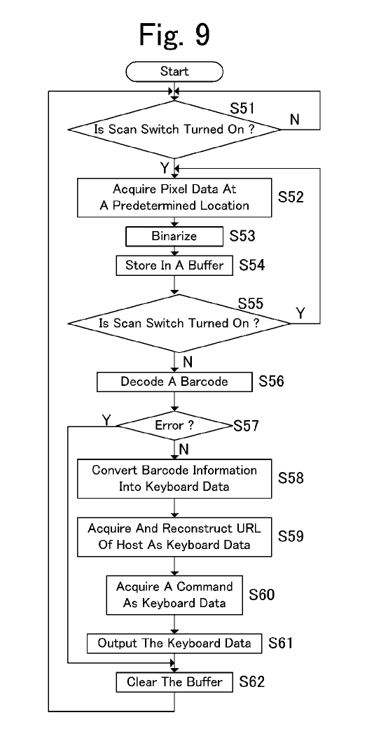

FIG. 9 is a flow chart for showing an example of the process of the barcode decoder 314 of FIG. 6. Referring to FIG. 9, in step S51, the barcode decoder 314 determines whether or not the scan switch 315 is turned on, the process returns to step S51 if OFF, and conversely the process proceeds to step S52 if ON.

In step S52, the barcode decoder 314 receives the pixel data P(t) at the predetermined location (n, m) from the mouse function unit 307. In step S53, the barcode decoder 314 compares the pixel data P(t) with the predetermined threshold value Th to binarize the pixel data P(t), and whereby obtains the binary data B(t). In step S54, the barcode decoder 314 stores the binary data B(t) in a buffer.

In step S55, the barcode decoder 314 determines whether or not the scan switch 315 is turned on, if ON, since it represents that the scan is being performed, the process returns to step S52, and conversely if OFF, since it represents that the scan has been completed, the process proceeds to step S56. In step S56, the barcode decoder 314 decodes the binary data B(t) as stored in the above buffer based on the known barcode decode technique.

When the barcode decoder 314 determines in the step S57 that the decode of the barcode 11 has not been completed correctly, the barcode decoder 314 proceeds to step S62 to clear the above buffer and then returns to step S51. On the other hand, when the barcode decoder 314 determines that the decode of the barcode 11 has been completed correctly, the barcode decoder 314 proceeds to step S58.

In step S58, the barcode decoder 314 converts the barcode information as the decoding result into keyboard data and stores it in a RAM (not shown in the figure). Then, in step S59, the barcode decoder 314 acquires URL of the host computer 1 (for example, “http://www.ssd.co.jp”) from a ROM (not shown in the figure) as keyboard data, appends the barcode information (for example, “4560256580016”) as keyboard data to the end of the URL, and stores it in the RAM (not shown in the figure) as a new URL (for example, “http://www.ssd.co.jp/?bc=4560256580016&sn=13222159”).

In step S60, the barcode decoder 314 acquires a command from the ROM (not shown in the figure) in the form of keyboard data which instructs the PC 61 to launch the browser and access the host computer 1, and stores the command in the RAM (not shown in the figure). The barcode decoder 314 outputs the keyboard data (the command and the URL) as obtained in steps S59 and S60 to the transmitter 318 in step S61, clears the above buffer in step S62, and then returns to step S51.

By the way, as has been discussed above, it is possible to further improve the convenience of the user by implementing the barcode reading function in the optical mouse. That is, since the PC 61 automatically transmits the barcode information to the host computer 1 in response to the command from the BC mouse 63 only by scanning the barcode 11 attached to a commodity using the BC mouse 63, the user can receive service in accordance with the barcode 11 from the host computer 1, without need for cumbersome operation performed by the user (the PC 61 need not be manipulated). In addition, since the PC 61 performs processing required for realizing the present system in response to the command from the BC mouse 63, it is possible to save the user the trouble of installing a new program in the PC 61 and so forth.

Needless to say, the BC mouse 63 serves also as a pointing device. Accordingly, the user can manipulate the PC 61 only by operating the BC mouse 63 after scanning the barcode 11 by the BC mouse 63, and whereby the structure is very user-friendly.

Also, In spite of the implementation of the imaging unit 310, the barcode 11 is decoded based on the pixel data which is located at the predetermined location and is temporally continuous, without using image analysis which decodes the barcode 11 based on the image of the barcode 11 in the obtained picture. Thus, the optical mouse based on the radically novel barcode reading method, which is nonconventional, is realized.

By the way, next, barcodes whose purposes are novel and a system for providing them will be described. For example, the novel barcodes apply to the remote barcode reader system of FIG. 1 as well as the barcodes 11.

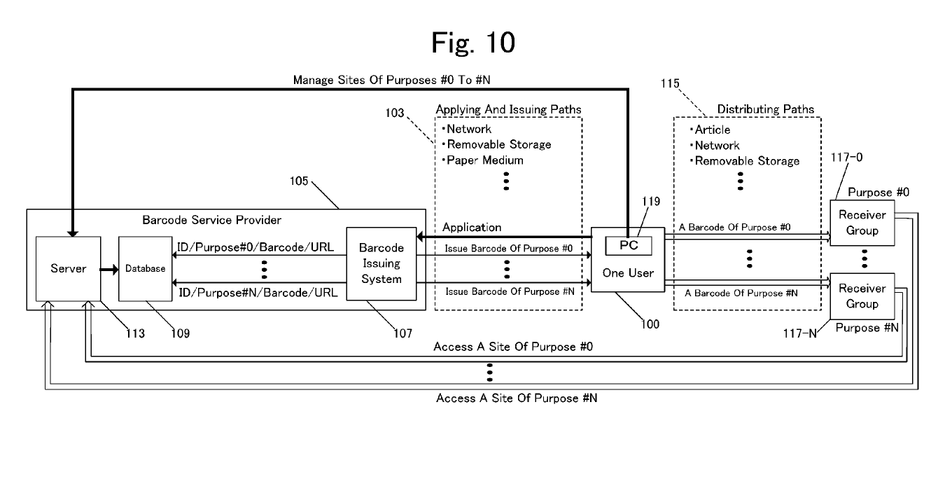

FIG. 10 is a schematic representation of a business model realized by a barcode service providing system in accordance with an embodiment of the present invention. Referring to FIG. 10, a certain user 100 applies for a barcode service with a barcode service provider 105. The user 100 is an individual, an enterprise, a store, and so on.

Then, a barcode issuing system 107 assigns a unique barcode 131 to the user 100 and provides it to the user 100. In this case, the user 100 can apply for issuing a plurality of kinds of barcodes 131, and it is not limited to one kind. That is, the user 100 can apply for issuing the different barcode 131 for each purpose #0 to #N (N is an integer). In this case, the barcode issuing system 107 issues the different barcode 131 for each purpose #0 to #N. When there is no need to distinguish the purposes #0 to #N, the term “purpose #n” is simply used.

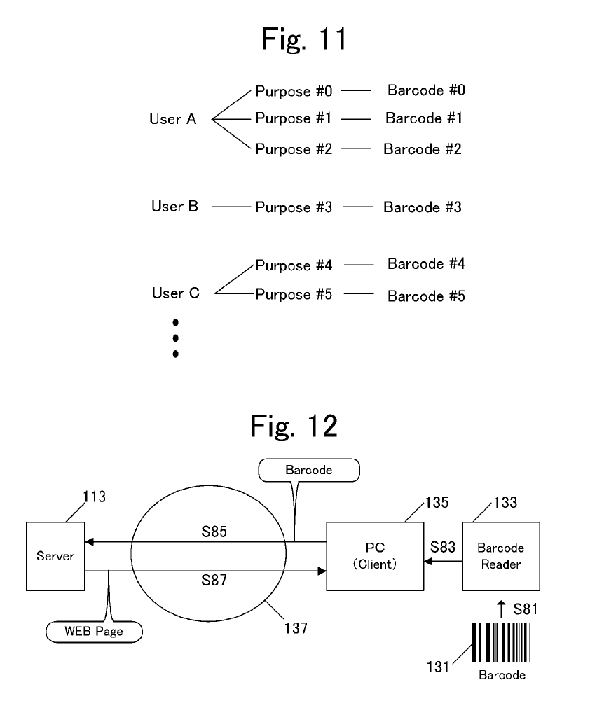

FIG. 11 is an explanatory view of barcode assignment in accordance with the present embodiment. Referring to FIG. 11, the barcodes (#0, . . . ) are assigned to not articles as in the prior art but the users (A, . . . ). Accordingly, the user 100 can attach the barcodes 131 to desired various articles even if the barcodes 131 are the same. In addition, if the user 100 has a plurality of kinds of the barcodes 131, the user 100 can use the different barcodes 131 for different purposes. Needless to say, in this case, the same barcodes 131 may be attached to the desired various articles.

Returning to FIG. 10, paths 103 for applying for and/or issuing the barcode may be optionally determined between the barcode service provider 105 and the user 100. Examples of the path of the application by the user 100 include applying via a network such as Internet, sending an application form by post or the like, and so on. Also, examples of the path (i.e., providing path) for issuing the barcode 131 by the barcode service provider 105 include providing the barcode 131 via a network such as Internet, providing a removable storage such as CD-ROM and a floppy disk which store the barcode 131, and providing a paper medium such as a decal on which the barcode 131 is printed.

When the barcode issuing system 107 issues the barcode 131 to the user 100, the barcode issuing system 107 relates the barcode 131 to a URL (Uniform Resource Locator) for each pair of the user 100 and the purpose #n, and stores them in a URL reference file of a data base 109. That is, the barcode issuing system 107 assigns the URL to each pair of the user 100 and the purpose #n. Because of this, a directory is assigned to each pair of the user 100 and the purpose #n in a server 113. Incidentally, the URL consists of a protocol, a host name, a directory, and a file name and so on.

The user 100 accesses the server 113 using a personal computer (PC) 119 to make and/or update an HTML file in the directory which is assigned to each purpose #n (i.e., each barcode 131), i.e., make and/or update contents for each purpose, and thus manages a WEB site for each purpose #n.

On the other hand, the user 100 distributes the different barcodes 131 for the respective purposes #0 to #N to receiver groups 117-0 to 117-N each of which includes a single receiver or a plurality of receivers. When there is no need to distinguish the receiver groups 117-0 to 117-N, the term “receiver group 117-n” is simply used. For example, the user 100 distributes the barcodes 131 corresponding to the purpose #0 to the receiver group 117-0 for the purpose #0 (private business), and distributes the barcodes 131 corresponding to the purpose #1 to the receiver group 117-1 for the purpose #1 (company business).

A path for distributing the barcodes 131 by the user 100 may be optionally determined. For example, the user 100 can attach the barcodes 131 to the desired various articles (including electrical information such as software, image data, and audio data, and a paper medium such as a magazine, a visiting card, a postal card, a catalogue, and a advertising leaflet) and then distribute the barcodes 131 together with the articles. For example, the user 100 can store the barcodes 131 in removable storages and then distribute the barcodes 131 together with the removable storages. For example, the user 100 can distribute the barcodes 131 via E-mail. For example, the user 100 can distribute the barcodes 131 through a WEB site.

The receiver in the receiver group 117-n, to which the barcode 131 corresponding to the purpose #n is distributed by the user 100, accesses the server 113 based on the barcode 131 corresponding to the purpose #n to visit a WEB site assigned to the barcode 131 corresponding to the purpose #n. As the result, the receiver can easily acquire information which the user 100 delivers.

FIG. 12 is a schematic view for showing the communication procedure between the receiver group 117-n of FIG. 10 and the server 113 of the barcode service provider 105. Referring to FIG. 12, it is assumed that the receiver in the receiver group 117-n of FIG. 10 owns the personal computer (PC) 135 and the barcode reader 133 coupled therewith. Incidentally, the PC 135 may be referred to as a client 135. In step S81, the receiver operates the barcode reader 133 to scan the barcode 131 as distributed. Then, the barcode reader 133 decodes the barcode 131 to obtain a character string represented by the barcode 131, i.e., the barcode information.

In step S83, the barcode reader 133 outputs the barcode information, which is the result of the decoding, as keyboard data to the PC 135. The PC 135 receives the barcode information as the keyboard data as outputted from the barcode reader 133, and then transmits it to the server 113 of the barcode service provider 105 through the network 137 in step S85. In this case, the PC 135 launches a browser in response to the command as the keyboard data as sent from the barcode reader 133 to transmit the barcode information. Accordingly, it is not acquired for the PC 135 to install dedicated software.

In step S87, the server 113 transmits information for displaying a WEB page corresponding to the barcode information as received from the PC 135 to the PC 135 through the network 137. Then, the PC 135 displays the WEB page based on the information as received.

Incidentally, the sever 113 corresponds to the host computer 1 of FIG. 1, the PC 135 corresponds to the terminal 5 of FIG. 1, the barcode reader 133 corresponds to the local barcode reader 7 of FIG. 1, and the network 137 corresponds to Internet 3 of FIG. 1.

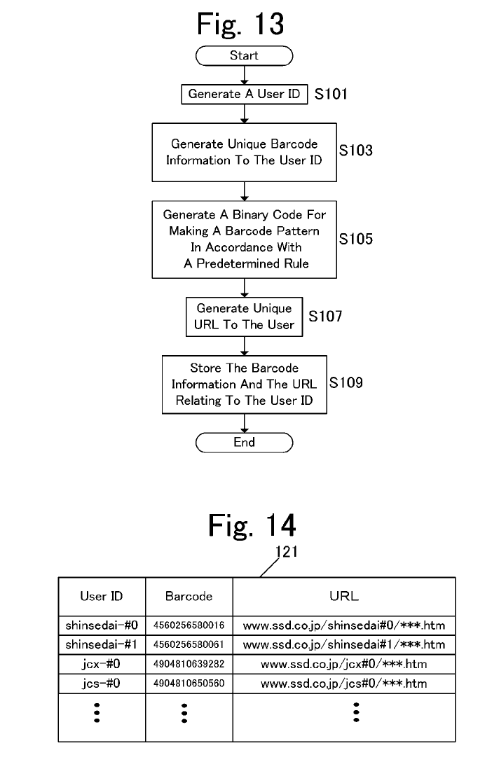

FIG. 13 is a flow chart for showing the process of issuing the barcode by the barcode issuing system 107 of FIG. 10. Referring to FIG. 13, the barcode issuing system 107 generates user identification information (user ID) in step S101. In step S103, the barcode issuing system 107 generates the unique barcode information (character string) to the generated user ID. In step S105, the barcode issuing system 107 generates a binary code for making a barcode pattern 131, which represents the barcode information, in accordance with a predetermined rule. In step S107, the barcode issuing system 107 generates a unique URL to the user ID, i.e., the generated barcode information. In step S109, the barcode issuing system relates the barcode information and the URL to the user ID, and stores them in the URL reference file of the database 109.

FIG. 14 is a schematic representation of the URL reference file 121 stored in the database 109 of FIG. 10. Referring to FIG. 14, the URL reference file 121 is a table in which the user IDs, the barcodes 131, and the URLs are related to one another. In this example, the user ID includes the information of the purpose #n. That is, the user ID includes a user identification section and a purpose identification section as hyphenated.

Meanwhile, the communication procedure among the barcode reader 133, the client 135, and the server 113 is the same as the communication procedure among the local barcode reader 7, the terminal 5, and the host computer 1. In this case, in step S31, the server 113 accesses the database 109, and refers to the URL reference file 121 to retrieve the URL (see FIG. 14) related to the received barcode 131. Then, in step S33, the server 113 transmits the URL acquired in step S31 to the client 135. Then, in step S25, the client 135 accesses the server 113 based on the received URL to display the WEB page.

Next, a modification of the barcode issuing system 107 will be described. In the modification, the barcode 131 represents a URL itself, which is designated by characters, numerals, and symbols.

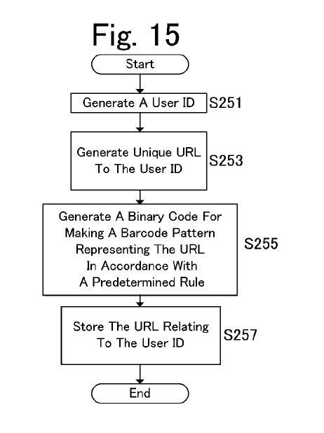

FIG. 15 is an explanatory view for showing the modification of the barcode issuing system 107. Referring to FIG. 15, in step S251, the modification of the barcode issuing system 107 generates the user ID. In step S253, the modification of the barcode issuing system 107 generates the unique URL to the user ID. In step S255, the modification of the barcode issuing system 107 generates a binary code for making a barcode pattern 131, which represents the URL, in accordance with a predetermined rule. In step S257, the modification of the barcode issuing system relates the URL to the user ID, and stores them in the database 109. In this way, the server 113 is not required the process for retrieving the URL (see step S31) by setting the barcode 131 to the URL itself.

By the way, as described above, in accordance with the present embodiment, the generated barcode 131 is related to the URL of the content made by the user 100 (see FIG. 14). Accordingly, a person to which the barcode 131 is distributed can access the content on the server 113 by sending the barcode 131 to the server 113 through the client 135. Since the barcode 131 is assigned to not an article but the user 100 and unique to the user, the user 100 of the barcode 131 can make contents independently of the article to which the barcode 131 is attached.

By comparison, in the case where a barcode is assigned to an article, since a person to which the barcode is distributed accesses so as to obtain information of the article, if the contents unrelated to the article are made, they not only proves to be disappointing but also the person will never again access on the basis of the barcode. If a user wants a person to access the contents of the user itself which do not depend on the article, as in the present embodiment, the barcode needs to be related to the user 100.

Also, since the barcode 131 is not assigned to the article, the user 100 can attach the barcodes 131 to the different articles even if the barcodes 131 are the same as each other, and also distribute only the barcode 131 independently of the articles.

Further, in the present embodiment, it is possible to issue a plurality of different barcodes 131 to one user. Accordingly, the user 100 can own the plurality of the different barcodes 131. That is, the user 100 can make the contents in accordance with the respective barcodes 131. Thus, the user 100 can deliver objective information to a person appropriate to the objective by distributing the different barcodes 131 to the different receivers in accordance with the purposes #n. That is, the same user may want to deliver many information items. In this case, since there is not only the desired information item but also the unnecessary information item, it is inconvenient for the receiver sides. Also, the same user may want not to deliver all information items to all persons. That is, he/she may want to deliver specific information item only to a particular person.

Further, in the modification, in addition to the above advantage, it is possible to decrease processing load of the server 113. Because, since the barcode 131 includes the URL in itself, the server 113 is not required the retrieving process of the URL (see step S31).

Meanwhile, the present invention is not limited to the above embodiment, and a variety of variations may be effected without departing from the spirit and scope thereof, as described in the following modification examples.

[1] Optical glass such as BK7, plastic such as PMMA (polymethylmethacrylate), sapphire, and so on may be used as material of the above lens 23, and the material thereof is not limited thereto. If the material of the lens 23 is the sapphire and so on whose refractive index is relatively high, the lens 29 is not necessarily required. Also, for example, optical glass such as BK7 and plastic such as PMMA may be used as material of the above lens 29.

[2] In the case of the above examples, the lens 23 is disposed to the outgoing aperture from which the light of the light emitting diode 33 is emitted. Alternatively, a pinhole as the outgoing aperture may be disposed in place of the lens 23. In this case, the diaphragm member 25 is not required.

[3] One way or another, it is possible to optionally form the optical system depending on specification and purpose as long as the light emitting diode 33 and the photo-transistor 31 are arranged as described above.

[4] In the case of the above examples, the USB cable 41 is used. However, the barcode reader 7 and the terminal 5 may be coupled with each other in a wireless manner.

[5] Various types of barcode readers as well as the above examples may be employed as the barcode reader 7. For example, a CCD touch scanner, a handheld laser scanner, a desktop laser scanner, a slot reader, and so on may be employed. In this case, preferably, the result of the decoding of the barcode 11 is transmitted to the terminal 5 as keyboard data, and the command represented by keyboard data is transmitted to the terminal 5. The reason is because of the realization of a user-friendly condition as described above.

[6] In the case of the above examples, there is no need to install dedicated software in the terminal 5 for transmitting the barcode 11 through a browser to the host computer 1, because the local barcode reader 7 is designed to output the command 57. However, it is also possible to omit the functionality of outputting the command 57 from the local barcode reader 7, by installing such dedicated software in the terminal 5. In this case, it is preferred to launch the dedicated software in response to the input of the barcode 11, and automatically transmit the barcode 11. Also, it is possible to have the local barcode reader 7 output a command to the dedicated software, which then transmits the barcode 11 to the host computer 1 in response to the command.

Furthermore, in the case of the above examples, the local barcode reader 7 is designed to output the URL 55 of the host computer 1, such that there is no need to input the URL 55 of the host computer to the terminal 5. However, it is also possible to omit the functionality of outputting the URL 55 from the local barcode reader 7 by prompting the user to input the URL 55 of the host computer 1, or by writing the above software to include the URL 55 in the terminal 5.

The local barcode reader 7 which does not output the URL 55 and the command 57 is equivalent to an ordinary barcode reader. Accordingly, an ordinarily available barcode reader can be used for the present system by installing such software in the terminal 5.

[7] In the case of the above examples, while the barcodes 11 and 131 are employed as the information to be transmitted to the host computer 1, the present invention is not limited thereto. For example, an electronic tag (IC tag) such as RFID (Radio Frequency Identification System) can be used. However, in this case, the information encoded in the electronic tag is read by an electronic tag reader (IC tag reader) in place of the barcode readers 7 and 133. Preferably, the electronic tag reader is designed to issue the same command as the barcode readers 7 and 133, and output the URL of the host computer 1. Also, while a one-dimensional barcode which is a one-dimensional code is used in the above examples, it is possible to use a two-dimensional barcode or QR code as a two-dimensional code.

[8] As physically viewed, the host computer 1 can be implemented with a single computer. Alternatively, the processes of the host computer 1 can be performed by a plurality of servers as distributed processing. Of course, in the case where distributed processing is employed, the respective computers may be located in the same country, or distributed in a plurality of countries. Meanwhile, the host computer 1 as referred to herein are devices which are implemented by means of hardware and/or software.

[9] It is also possible to use the barcode recognition feature implemented with the camera of a cellular phone in place of the barcode reader 7. This is true in the case of the recognition of QR codes. In this case, for example, software is installed in the cellular phone for transmitting the barcode to the host computer 1.

[10] Also, the term “unit” as used herein does not always refer to a physical device but can also refer to software for implementing the functions of this unit. Furthermore, the functions of one unit may be implemented by two or more physical devices. Conversely, the functions of two or more units may be implemented by one physical device.

While the present invention has been described in detail in terms of embodiments, it is apparent that those skilled in the art will recognize that the invention is not limited to the embodiments as explained in this application. The present invention can be practiced with modification and alteration within the spirit and scope of the present invention as defined by the appended any one of claims.

1. A barcode reader comprising:
a light emitting unit; and
a light receiving unit,
wherein said light receiving unit is arranged to overlap with said light emitting unit in a longitudinal direction of said barcode reader and on a side, to which said light emitting unit emits light, and
wherein said light emitting unit and said light receiving unit are arranged in a linear fashion, or, on a substantial same axis.

2. A barcode reader comprising:
a light emitting unit; and
a light receiving unit,
wherein said light receiving unit is arranged between an outgoing aperture from which light of said light emitting unit is emitted outside and said light emitting unit, and
wherein said light emitting unit and said light receiving unit are arranged in a linear fashion, or, on a substantial same axis.

3. The barcode reader as claimed in claim 2 further comprising:
a first lens disposed at the outgoing aperture,
wherein said first lens is a spherical lens.

4. The barcode reader as claimed in claim 2 further comprising:
a second lens disposed between said outgoing aperture and said light receiving unit,
wherein said second lens is a convex lens.

5. The barcode reader as claimed in claim 3 further comprising:
a diaphragm member disposed in contiguity with said first lens,
wherein said diaphragm member has an opening, which restricts emitted light which enters said first lens from said light emitting unit and emitted light which is incoming from said first lens and then travels to said light receiving unit.

6-7. (canceled)

8. The barcode reader as claimed in claim 1 wherein said light emitting unit and said light receiving unit are arranged at a predetermined distance from each other.

9. The barcode reader as claimed in claim 1 further comprising:
an information processing unit operable to decode the barcode based on light converted into an electrical signal, and the light has been emitted by said light emitting unit, irradiated a barcode, reflected by the barcode, and received by said light receiving unit,
wherein said information processing unit converts a result of decoding of the barcode into keyboard data, and outputs the result of the decoding as the keyboard data and a predetermined command as keyboard data for having a predetermined computer perform a predetermined process using the result of the decoding.

10. The barcode reader as claimed in claim 9 wherein said information processing unit outputs address information of a predetermined server as keyboard data to the predetermined computer, and
wherein the predetermined command is a command for having the predetermined computer transmit the result of the decoding of the barcode to the predetermined server indicated by the address information.

11-28. (canceled)

29. The barcode reader as claimed in claim 3 further comprising:
a second lens disposed between said outgoing aperture and said light receiving unit,
wherein said second lens is a convex lens.

30. The barcode reader as claimed in claim 5 further comprising:
a diaphragm member disposed in contiguity with said first lens,
wherein said diaphragm member has an opening, which restricts emitted light which enters said first lens from said light emitting unit and emitted light which is incoming from said first lens and then travels to said light receiving unit.

31. The barcode reader as claimed in claim 2 wherein said light emitting unit and said light receiving unit are arranged at a predetermined distance from each other.

32. The barcode reader as claimed in claim 30 wherein said light emitting unit and said light receiving unit are arranged at a predetermined distance from each other.

33. The barcode reader as claimed in claim 2 further comprising:
an information processing unit operable to decode the barcode based on light converted into an electrical signal, and the light has been emitted by said light emitting unit, irradiated a barcode, reflected by the barcode, and received by said light receiving unit,
wherein said information processing unit converts a result of decoding of the barcode into keyboard data, and outputs the result of the decoding as the keyboard data and a predetermined command as keyboard data for having a predetermined computer perform a predetermined process using the result of the decoding.

34. The barcode reader as claimed in claim 30 further comprising:
an information processing unit operable to decode the barcode based on light converted into an electrical signal, and the light has been emitted by said light emitting unit, irradiated a barcode, reflected by the barcode, and received by said light receiving unit,
wherein said information processing unit converts a result of decoding of the barcode into keyboard data, and outputs the result of the decoding as the keyboard data and a predetermined command as keyboard data for having a predetermined computer perform a predetermined process using the result of the decoding.

35. The barcode reader as claimed in claim 33 wherein said information processing unit outputs address information of a predetermined server as keyboard data to the predetermined computer, and
wherein the predetermined command is a command for having the predetermined computer transmit the result of the decoding of the barcode to the predetermined server indicated by the address information.

36. The barcode reader as claimed in claim 34 wherein said information processing unit outputs address information of a predetermined server as keyboard data to the predetermined computer, and
wherein the predetermined command is a command for having the predetermined computer transmit the result of the decoding of the barcode to the predetermined server indicated by the address information.
